(19) United States
(12) Patent Application Publication
(10) Pub. No.: US 2026/0302930 A1
(43) Pub. Date: Oct. 1, 2026

(54) SUPPLY FILTER CIRCUIT

(71) Applicant: NXP USA, Inc., AUSTIN, TX (US)

(72) Inventors: Mahraj Sivaraj, Cedar Park, TX (US); John Pigott, Phoenix, AZ (US)

(21) Appl. No.: 19/094,219

(22) Filed: Mar. 28, 2025

(51) Int. Cl. H02M 1/15; H02M 3/07

(52) U.S. Cl. CPC H02M 1/15; H02M 3/07

(57) ABSTRACT

Embodiments of a supply filter circuit are disclosed. In an embodiment, a supply filter circuit includes a first transistor coupled to an input voltage, a charge pump coupled to the first transistor and a second transistor coupled to the first transistor and configured to output a filtered output voltage based on the input voltage, where the first and second transistors have different threshold voltages.

### BACKGROUND

An input voltage (e.g., a 3.3 Volt (V) or 5V supply) may be shared between multiple circuits. A supply ripple in an input voltage can disrupt the operation of a circuit. Therefore, there is a need for a supply filter circuit that can filter an input voltage with an efficient circuit area.

### SUMMARY

Embodiments of a supply filter circuit are disclosed. In an embodiment, a supply filter circuit includes a first transistor coupled to an input voltage, a charge pump coupled to the first transistor and a second transistor coupled to the first transistor and configured to output a filtered output voltage based on the input voltage, where the first and second transistors have different threshold voltages. Other embodiments are also disclosed.

In an embodiment, the supply filter circuit further includes a voltage source coupled to the second transistor.

In an embodiment, the voltage source is coupled to a gate terminal of the second transistor.

In an embodiment, the supply filter circuit further includes a capacitor coupled to the first transistor.

In an embodiment, the charge pump is coupled to a gate terminal of the first transistor.

In an embodiment, the supply filter circuit further includes a resistor and a capacitor coupled to the second transistor.

In an embodiment, the supply filter circuit further includes a low-dropout regulator (LDO) coupled to the charge pump.

In an embodiment, the LDO is configured to generate a drive voltage for the charge pump.

In an embodiment, the supply filter circuit further includes a switch coupled to the charge pump and to the first transistor.

In an embodiment, the first and second transistors include N-channel Metal-Oxide-Semiconductor (NMOS) transistors.

In an embodiment, a body of the first transistor or the second transistor is coupled to a fixed voltage.

In an embodiment, the supply filter circuit further includes a third transistor coupled to the charge pump and configured to output a second filtered output voltage based on the input voltage.

In an embodiment, the first, second, and third transistors include N-channel Metal-Oxide-Semiconductor (NMOS) transistors.

In an embodiment, a supply filter circuit includes a first N-channel Metal-Oxide-Semiconductor (NMOS) transistor coupled to an input voltage, a charge pump coupled to a gate terminal of the first NMOS transistor, and a second NMOS transistor coupled to the first NMOS transistor and configured to output a filtered output voltage based on the input voltage, where the first and second NMOS transistors have different threshold voltages.

In an embodiment, the supply filter circuit further includes a voltage source coupled to a gate terminal of the second NMOS transistor.

In an embodiment, the supply filter circuit further includes a resistor and a capacitor coupled to the second NMOS transistor.

In an embodiment, the supply filter circuit further includes a low-dropout regulator (LDO) coupled to the charge pump and configured to generate a drive voltage for the charge pump.

In an embodiment, the supply filter circuit further includes a switch coupled to the charge pump and to the first NMOS transistor.

In an embodiment, a body of the first NMOS transistor or the second NMOS transistor is coupled to a fixed voltage.

In an embodiment, a supply filter circuit includes a first NMOS transistor coupled to an input voltage, a charge pump coupled to a gate terminal of the first NMOS transistor, a second NMOS transistor coupled to the first NMOS transistor and configured to output a filtered output voltage based on the input voltage, where the first and second NMOS transistors have different threshold voltages, and an LDO coupled to the charge pump and configured to generate a drive voltage for the charge pump, where a body of the first NMOS transistor or the second NMOS transistor is coupled to a fixed voltage.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a supply filter circuit in accordance with an embodiment of the invention.

FIG. 2 depicts a supply filter circuit in accordance with an embodiment of the invention.

FIG. 3 depicts a supply filter circuit with a low-dropout regulator (LDO) in accordance with an embodiment of the invention.

FIG. 4 depicts a supply filter circuit with multiple loads in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

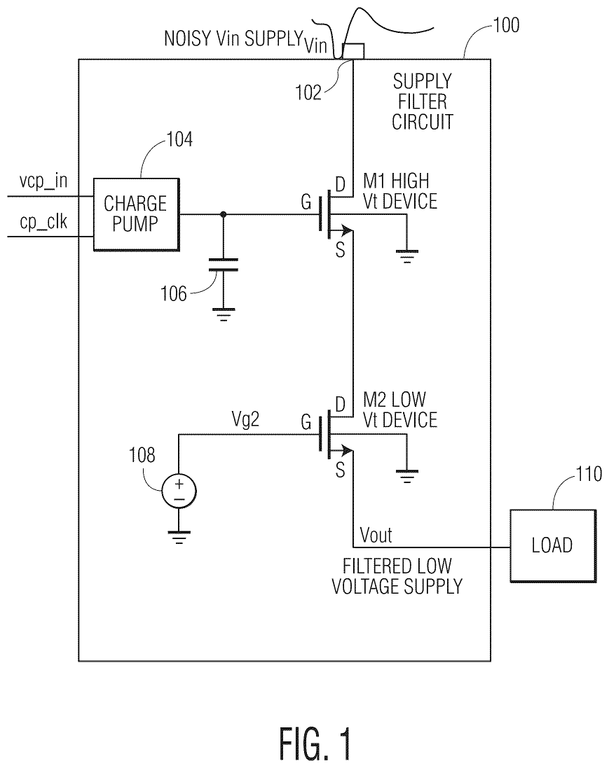

FIG. 1 depicts a supply filter circuit 100 in accordance with an embodiment of the invention. In the embodiment depicted in FIG. 1, the supply filter circuit 100 includes a high voltage transistor M1, a low voltage transistor M2, a charge pump 104, a capacitor 106, and a voltage source 108. In some embodiments, the supply filter circuit 100 is configured to filter an input voltage V_{IN} received at an input terminal/pin 102 to generate an output voltage V_{OUT} that is applied to a load 110. In the embodiment depicted in FIG. 1, the high voltage transistor M1 and the low voltage transistor M2 are N-channel Metal-Oxide-Semiconductor (NMOS) transistors with different threshold voltages. Specifically, the threshold voltage of the transistor M1 is higher than the threshold voltage of the transistor M2. In some embodiments, the high voltage transistor M1 and the low voltage transistor M2 are implemented using other types of transistors. The supply filter circuit 100 can be used in various applications, such as consumer or enterprise applications, medical applications, computer applications, and/or industrial applications. The supply filter circuit 100 may be fully or partially implemented as at least one integrated circuit (IC) device. In some embodiments, the high voltage transistor M1, the low voltage transistor M2, the charge pump 104, the capacitor 106, and the voltage source 108 of the supply filter circuit 100 are located in the same substrate and are implemented as one IC device. Although the depicted supply filter circuit 100 is shown in FIG. 1 with certain components and described with certain functionality herein, other embodiments of the supply filter circuit 100 may include fewer or more components to implement the same, less, or more functionality. In addition, although the supply filter circuit 100 is shown in FIG. 1 as being connected in a certain topology, the network topology of the supply filter circuit 100 is not limited to the topology shown in FIG. 1.

In the embodiment depicted in FIG. 1, the supply filter circuit 100 can mitigate a large supply ripple on the input voltage V_{IN} received at the input terminal/pin 102 without the need for a dedicated regulator. In an example, the supply ripple is a function of the value of the input voltage V_{IN}. For higher values of the input voltage V_{IN} (e.g., 5 Volt (V)), the ripple can be around 1V, and at 3.3V the ripple can be around 500 mV. This relationship exists due to the gate drive transient currents of a direct current (DC)-DC converter connected to the input terminal/pin 102 being a function of the input voltage V_{IN}. In some implementations (e.g., a custom flip-chip package with limited number of pins), the input voltage V_{IN} (e.g., a 5V supply) is shared between all analog circuitry, a gate drive circuitry and boot capacitor refresh circuitry of a DC-DC converter. During low side switching of a buck DC-DC converter, large transient currents are drawn from the shared V_{IN} pin. Parasitic inductances can cause a large voltage spike on the shared V_{IN} supply, which can be up to 20% of the nominal voltage. Although it lasts for only a few nanoseconds, this large signal spike can affect a sensitive circuitry such as a 12-bit analog-to-digital converter (ADC) system with a least significant bit (LSB), which is the smallest input voltage change that can be converted by an ADC, in the hundreds of microvolts (μV) range. For an Automotive Safety Integrity Levels (ASIL) B: Brake lights, rear view camera, instrument cluster power management IC with two 15 A DC-DC buck converters capable of running in dual phase mode, an ASIL B rated automotive safety system requires that the output voltage of the buck converter is monitored, which can be done by a high precision 12-bit ADC system consisting of a 12-bit Successive Approximation Register (SAR) ADC, input buffer and reference generating regulators. A simple RC filter can pose a challenge because of a tradeoff between an area the capacitor versus the voltage drop across the resistor. High voltage capacitors required for a RC filter typically are not high density. In the embodiment depicted in FIG. 1, the supply filter circuit 100 uses the charge pump 104 to increase the headroom of the filtered output voltage and uses the NMOS transistors M1, M2 with different thresholds to achieve high large signal supply rejection at different input voltage levels. Specifically, the supply filter circuit 100 uses a combination of NMOS transistors M1, M2 with different threshold voltages that can attenuate the large supply ripple when the transistors M1, M2 are biased in their saturation region. An NMOS transistor in saturation can reject a ripple that dips up to a threshold voltage below and up to the maximum rating of the drain-source voltage V_{ds}, in other words, the drain voltage of the NMOS transistor can drop to only a threshold voltage below the gate voltage to maintain saturation. The charge pump 104 or a higher available voltage can be used to bias the gate of the NMOS transistor M1 to increase the headroom of sensitive circuits that it supplies. In the embodiment depicted in FIG. 1, a voltage V_{CP_IN} and a clock signal CP_CLK are input into the charge pump 104, which generates an output voltage that is applied to the gate terminal of the transistor M1 and the capacitor 106. In some embodiments, the capacitor 106 is connected to a fixed voltage, such as, the ground (zero volt).

In the embodiment depicted in FIG. 1, the NMOS transistor M1 is coupled to the input voltage V_{IN} received at the input terminal 102, the charge pump 104 is coupled to the gate terminal G of the NMOS transistor M1 and the capacitor 106, and the NMOS transistor M2 is coupled to the NMOS transistor M1 and configured to output a filtered output voltage V_{OUT} based on the input voltage V_{IN}. In the embodiment depicted in FIG. 1, the drain terminal D of the NMOS transistor M1 is coupled to the input terminal 102, the voltage source 108 is coupled to the gate terminal G of the NMOS transistor M2, the drain terminal D of the NMOS transistor M2 is coupled to the source terminal S of the NMOS transistor M1, and the source terminal S of the NMOS transistor M2 is coupled to the load 110.

In the embodiment depicted in FIG. 1, the NMOS transistor M1 is a high voltage transistor with a larger threshold voltage VT, allowing it to reject more ripple, which comes at the cost of headroom. To alleviate the headroom issue, the charge pump 104 or a suitable supply can be used to increase the gate voltage of the NMOS transistor M1. The NMOS transistor M1 helps rejecting the ripple or noise at higher V_{IN}. Because the ripple is a function of the input voltage V_{IN}, for a lower input voltage V_{IN}, the ripple is also lower in magnitude.

In the embodiment depicted in FIG. 1, the transistor M2 is a low voltage device, with a lower threshold voltage, and is used to reject the ripple at a lower V_{IN} voltage. The gate terminal S of the transistor M2 can be biased using a voltage reference V_{g2} provided by the voltage source 108 or a resistor. In some embodiments, the voltage source 108 is connected to a fixed voltage, such as, the ground (zero volt). In some embodiments, the threshold voltage of each transistor M1 or M2 is increased by connecting the body of the transistor to a fixed voltage (e.g., the ground).

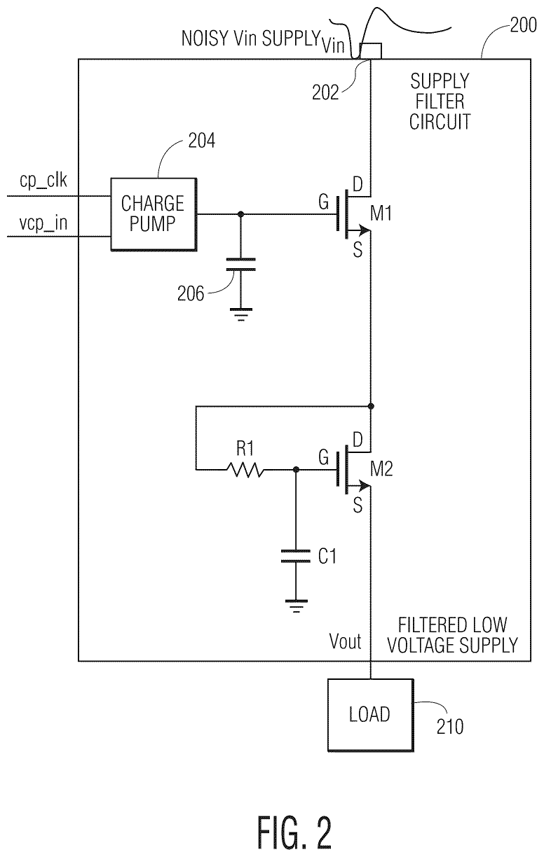

FIG. 2 depicts a supply filter circuit 200 in accordance with an embodiment of the present invention. The supply filter circuit 200 depicted in FIG. 2 is an embodiment of the supply filter circuit 100 depicted in FIG. 1. However, the supply filter circuit 100 depicted in FIG. 1 is not limited to the embodiment depicted in FIG. 2. In the embodiment depicted in FIG. 2, the supply filter circuit 200 includes a high voltage transistor M1, a low voltage transistor M2, a charge pump 204, a capacitor 206, a resistor R1, and a capacitor C1. In some embodiments, the supply filter circuit 200 is configured to filter an input voltage V_{IN} received at an input terminal/pin 202 to generate an output voltage V_{OUT} that is applied to a load 210. In the embodiment depicted in FIG. 2, the high voltage transistor M1 and the low voltage transistor M2 are NMOS transistors with different threshold voltages. Specifically, the threshold voltage of the transistor M1 is higher than the threshold voltage of the transistor M2. In some embodiments, the high voltage transistor M1 and the low voltage transistor M2 are implemented using other types of transistors. The supply filter circuit 200 may be fully or partially implemented as at least one IC device. In some embodiments, the high voltage transistor M1, the low voltage transistor M2, the charge pump 204, the capacitor 206, the resistor R1, and the capacitor C1 of the supply filter circuit 200 are located in the same substrate and are implemented as one IC device. Although the depicted supply filter circuit 200 is shown in FIG. 2 with certain components and described with certain functionality herein, other embodiments of the supply filter circuit 200 may include fewer or more components to implement the same, less, or more functionality. In addition, although the supply filter circuit 200 is shown in FIG. 2 as being connected in a certain topology, the network topology of the supply filter circuit 200 is not limited to the topology shown in FIG. 2.

In the embodiment depicted in FIG. 2, the supply filter circuit 200 can mitigate a large supply ripple on the input voltage V_{IN} received at the input terminal/pin 202 without the need for a dedicated regulator. In the embodiment depicted in FIG. 2, the supply filter circuit 200 uses the charge pump 204 to increase the headroom of the filtered output voltage and uses the NMOS transistors M1, M2 with different thresholds to achieve high large signal supply rejection at different input voltage levels. Specifically, the supply filter circuit 200 uses a combination of NMOS transistors M1, M2 with different threshold voltages that can attenuate the large supply ripple when the transistors M1, M2 are biased in their saturation region. The charge pump 204 or a higher available voltage can be used to bias the gate of the NMOS transistor M1 to increase the headroom of sensitive circuits that it supplies. In the embodiment depicted in FIG. 2, a voltage V_{CP_IN} and a clock signal CP_CLK are input into the charge pump 204, which generates an output voltage that is applied to the gate terminal of the transistor M1 and the capacitor 206. In some embodiments, the capacitor 206 is connected to a fixed voltage, such as, the ground (zero volt).

In the embodiment depicted in FIG. 2, the NMOS transistor M1 is coupled to the input voltage V_{IN} received at the input terminal 202, the charge pump 204 is coupled to the gate terminal G of the NMOS transistor M1 and the capacitor 206, and the NMOS transistor M2 is coupled to the NMOS transistor M1 and configured to output a filtered output voltage V_{OUT} based on the input voltage V_{IN}. In the embodiment depicted in FIG. 2, the drain terminal D of the NMOS transistor M1 is coupled to the input terminal 202, the resistor R1 is coupled to the gate terminal G of the NMOS transistor M2, the capacitor C1 is coupled to the gate terminal G of the NMOS transistor M2 and the source terminal S of the NMOS transistor M1, and the source terminal S of the NMOS transistor M2 is coupled to the load 210. In the embodiment depicted in FIG. 2, the NMOS transistor M1 is a high voltage transistor with a larger threshold voltage VT, allowing it to reject more ripple, which comes at the cost of headroom. To alleviate the headroom issue, the charge pump 204 or a suitable supply can be used to increase the gate voltage of the NMOS transistor M1. The NMOS transistor M1 helps rejecting the ripple or noise at higher V_{IN}. Because the ripple is a function of the input voltage V_{IN}, for a lower input voltage V_{IN}, the ripple is also lower in magnitude. In the embodiment depicted in FIG. 2, the NMOS transistor M2 is a low voltage device, with a lower threshold voltage, and is used to reject the ripple at a lower V_{IN} voltage. The gate terminal G of the NMOS transistor M2 is biased using the resistor R1 and the capacitor C1, which may be connected to a fixed voltage, such as, the ground (zero volt). In some embodiments, the resistor R1 has a resistance value of several megohms and the capacitor C1 has a capacitance value of several picofarads. In some embodiments, the threshold voltage of each NMOS transistor M1 or M2 is increased by connecting the body of the transistor to the ground.

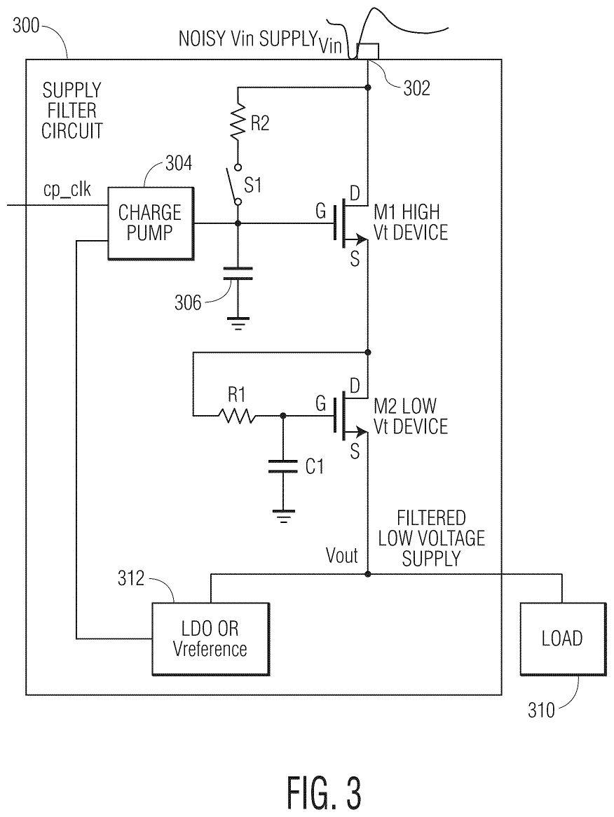

In some embodiments, a suitable reference voltage, such as, a low-dropout regulator (LDO) output voltage, can be as the reference for a charge pump. After the LDO powers up, it can supply the charge pump. FIG. 3 depicts a supply filter circuit 300 with an LDO 312 in accordance with an embodiment of the invention. The supply filter circuit 300 depicted in FIG. 3 is an embodiment of the supply filter circuit 100 depicted in FIG. 1. However, the supply filter circuit 100 depicted in FIG. 1 is not limited to the embodiment depicted in FIG. 3. In the embodiment depicted in FIG. 3, the supply filter circuit 300 includes a high voltage transistor M1, a low voltage transistor M2, a charge pump 304, a capacitor 306, a resistor R1, a capacitor C1, a switch S1, a resistor R2, and the LDO 312 or a voltage source circuit that can provide a reference voltage. In the embodiment depicted in FIG. 3, the LDO 312 is coupled to the charge pump 304 and is configured to generate a drive voltage for the charge pump 304. In some embodiments, the supply filter circuit 300 is configured to filter an input voltage V_{IN} received at an input terminal/pin 302 to generate an output voltage V_{OUT} that is applied to a load 310. In the embodiment depicted in FIG. 3, the high voltage transistor M1 and the low voltage transistor M2 are NMOS transistors with different threshold voltages. Specifically, the threshold voltage of the transistor M1 is higher than the threshold voltage of the transistor M2. In some embodiments, the high voltage transistor M1 and the low voltage transistor M2 are implemented using other types of transistors. The supply filter circuit 300 may be fully or partially implemented as at least one IC device. In some embodiments, the high voltage transistor M1, the low voltage transistor M2, the charge pump 304, the capacitor 306, the resistor R1, the capacitor C1, the switch S1, the resistor R2, and the LDO 312 of the supply filter circuit 300 are located in the same substrate and are implemented as one IC device. Although the depicted supply filter circuit 300 is shown in FIG. 3 with certain components and described with certain functionality herein, other embodiments of the supply filter circuit 300 may include fewer or more components to implement the same, less, or more functionality. In addition, although the supply filter circuit 300 is shown in FIG. 3 as being connected in a certain topology, the network topology of the supply filter circuit 300 is not limited to the topology shown in FIG. 3.

In the embodiment depicted in FIG. 3, the supply filter circuit 300 can mitigate a large supply ripple on the input voltage V_{IN} received at the input terminal/pin 302 without the need for a dedicated regulator. In the embodiment depicted in FIG. 3, the supply filter circuit 300 uses the charge pump 304 to increase the headroom of the filtered output voltage and uses the NMOS transistors M1, M2 with different thresholds to achieve high large signal supply rejection at different input voltage levels. Specifically, the supply filter circuit 300 uses a combination of NMOS transistors M1, M2 with different threshold voltages that can attenuate the large supply ripple when the transistors M1, M2 are biased in their saturation region. The charge pump 304 or a higher available voltage can be used to bias the gate of the NMOS transistor M1 to increase the headroom of sensitive circuits that it supplies. In the embodiment depicted in FIG. 3, a clock signal CP_CLK and a voltage that is generated by the LDO 312 are input into the charge pump 304, which generates an output voltage that is applied to the gate terminal of the transistor M1, the switch S1, and the capacitor 306. In some embodiments, the capacitor 306 is connected to a fixed voltage, such as, the ground (zero volt).

In the embodiment depicted in FIG. 3, the NMOS transistor M1 is coupled to the input voltage V_{IN} received at the input terminal 302, the charge pump 304 is coupled to the gate terminal G of the NMOS transistor M1, the capacitor 306, and the switch S1, and the NMOS transistor M2 is coupled to the NMOS transistor M1 and configured to output a filtered output voltage V_{OUT} based on the input voltage V_{IN}. In the embodiment depicted in FIG. 3, the drain terminal D of the NMOS transistor M1 is coupled to the input terminal 302, the resistor R1 is coupled to the gate terminal G of the NMOS transistor M2 and the drain terminal D of the NMOS transistor M2, the capacitor C1 is coupled to the gate terminal G of the NMOS transistor M2 and a fixed voltage (e.g., the ground), and the source terminal S of the NMOS transistor M2 is coupled to the load 310 and to the LDO 312 such that the filtered output voltage V_{OUT} is applied to the load 310 and to the LDO 312. In the embodiment depicted in FIG. 3, the NMOS transistor M1 is a high voltage transistor with a larger threshold voltage VT, allowing it to reject more ripple, which comes at the cost of headroom. To alleviate the headroom issue, the charge pump 304 or a suitable supply can be used to increase the gate voltage of the NMOS transistor M1. The NMOS transistor M1 helps rejecting the ripple or noise at higher V_{IN}. Because the ripple is a function of the input voltage V_{IN}, for a lower input voltage V_{IN}, the ripple is also lower in magnitude. In the embodiment depicted in FIG. 3, the NMOS transistor M2 is a low voltage device, with a lower threshold voltage, and is used to reject the ripple at a lower V_{IN} voltage. The gate terminal of the NMOS transistor M2 is biased using the resistor R1 and the capacitor C1, which may be connected to a fixed voltage, such as, the ground (zero volt). In some embodiments, the resistor R1 has a resistance value of several megohms and the capacitor C1 has a capacitance value of several picofarads. In some embodiments, the threshold voltage of each NMOS transistor M1 or M2 is increased by connecting the body of the transistor to the ground.

In an example operation of the supply filter circuit 300, during power up, the switch S1 is closed (i.e., conductive), and the resistor R2 keeps the NMOS transistor M1 on, which allows a current to flow to the load 310. Once the LDO 312 or a reference voltage circuit powers up, a POR (power on reset)/UVDET signal can be used to open the switch S1 to allow the charge pump 304 to take over the gate voltage of the NMOS transistor M1. In some embodiments, a digital control circuit (not shown) is used to open the switch S1 after a suitable time, by which the reference for the charge pump is enabled. In some embodiments, to further mitigate the input ripple, RC filters can be added if required.

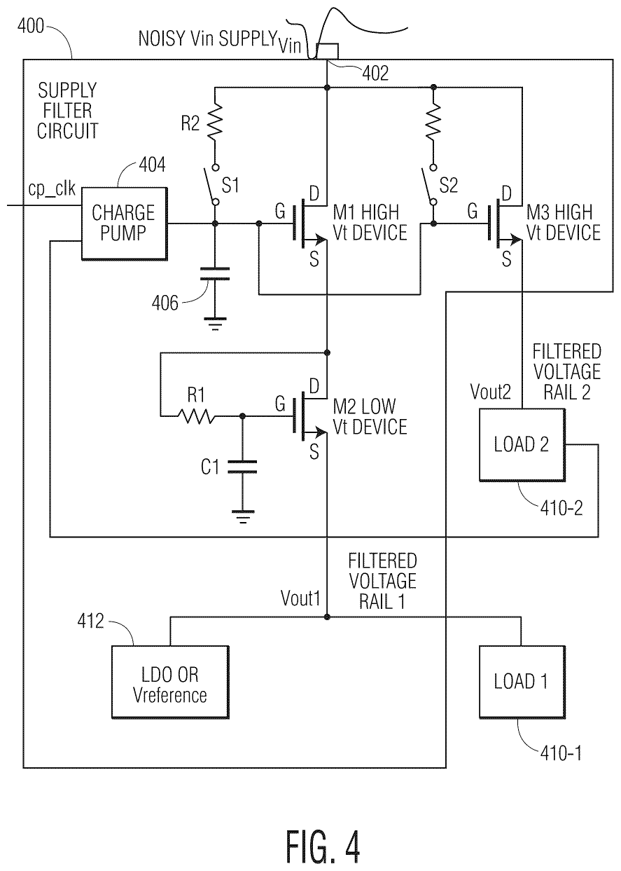

FIG. 4 depicts a supply filter circuit 400 with multiple loads 410-1, 410-2 in accordance with an embodiment of the invention. The supply filter circuit 400 depicted in FIG. 4 is an embodiment of the supply filter circuit 100 depicted in FIG. 1. However, the supply filter circuit 100 depicted in FIG. 1 is not limited to the embodiment depicted in FIG. 4. In the embodiment depicted in FIG. 4, the supply filter circuit 400 includes high voltage transistors M1, M3, a low voltage transistor M2, a charge pump 404, a capacitor 406, a resistor R1, a capacitor C1, a switch S1, a resistor R2, a switch S2, and a low-dropout regulator (LDO) 412 or a voltage source circuit that can provide a reference voltage. In some embodiments, the supply filter circuit 400 is configured to filter an input voltage V_{IN} received at an input terminal/pin 402 to generate an output voltage V_{OUT1} that is applied to the load 410-1 and an output voltage V_{OUT2} that is applied to the load 410-2. In the embodiment depicted in FIG. 4, the high voltage transistors M1, M3 and the low voltage transistor M2 are NMOS transistors with different threshold voltages. Specifically, the threshold voltage of the transistors M1, M3 is higher than the threshold voltage of the transistor M2. In some embodiments, the high voltage transistors M1, M3 and the low voltage transistor M2 are implemented using other types of transistors. In some embodiments, the load 2 410-2 is a voltage regulator that provides a suitable output voltage to the charge pump 404. For example, the output voltage to the charge pump 404 is in a voltage range such that after being boosted by the charge pump 404, the output of the charge pump provides enough gate voltage for the transistor M1. The supply filter circuit 400 may be fully or partially implemented as at least one IC device. In some embodiments, the high voltage transistor M1, the low voltage transistor M2, the high voltage transistor M3, the charge pump 404, the capacitor 406, the resistor R1, the capacitor C1, the switch S1, the resistor R2, the switch S2, and the LDO 412 of the supply filter circuit 400 are located in the same substrate and are implemented as one IC device. Although the depicted supply filter circuit 400 is shown in FIG. 4 with certain components and described with certain functionality herein, other embodiments of the supply filter circuit 400 may include fewer or more components to implement the same, less, or more functionality. In addition, although the supply filter circuit 400 is shown in FIG. 4 as being connected in a certain topology, the network topology of the supply filter circuit 400 is not limited to the topology shown in FIG. 4.

In the embodiment depicted in FIG. 4, the supply filter circuit 400 can mitigate a large supply ripple on the input voltage V_{IN} received at the input terminal/pin 402 without the need for a dedicated regulator. In the embodiment depicted in FIG. 4, the supply filter circuit 400 uses the charge pump 404 to increase the headroom of the filtered output voltage and uses different NMOS transistors M1, M2, and M3 with different thresholds to achieve high large signal supply rejection at different input voltage levels. Specifically, the supply filter circuit 400 uses a combination of NMOS transistors M1, M2, and M3 with different threshold voltages that can attenuate the large supply ripple when the transistors M1, M2, and M3 are biased in their saturation region. The charge pump 404 or a higher available voltage can be used to bias the gate terminals of the NMOS transistors M1, M3 to increase the headroom of sensitive circuits that they supply. In the embodiment depicted in FIG. 4, a clock signal CP_CLK and a voltage that is generated by the LDO 412 are input into the charge pump 404, which generates an output voltage that is applied to the gate terminals of the transistors M1, M3, the switches S1, S2, and the capacitor 406. In some embodiments, the capacitor 406 is connected to a fixed voltage, such as, the ground (zero volt).

In the embodiment depicted in FIG. 4, the NMOS transistors M1, M3 are coupled to the input voltage V_{IN} received at the input terminal 402, the charge pump 404 is coupled to the gate terminal G of the NMOS transistor M1 and the gate terminal G of the NMOS transistor M3, the capacitor 406, and the switches S1, S2, and the NMOS transistor M2 is coupled to the NMOS transistor M1 and configured to output a filtered output voltage V_{OUT} based on the input voltage V_{IN}. In the embodiment depicted in FIG. 4, the drain terminal D of the NMOS transistor M1 and the drain terminal D of the NMOS transistor M3 are coupled to the input terminal 402, the resistor R1 is coupled to the gate terminal G of the NMOS transistor M2 and the drain terminal D of the NMOS transistor M2, the capacitor C1 is coupled to the gate terminal G of the NMOS transistor M2 and a fixed voltage (e.g., the ground), the source terminal S of the NMOS transistor M3 is coupled to the load 410-2 such that the filtered output voltage V_{OUT2} is applied to the load 410-2, and the source terminal S of the NMOS transistor M2 is coupled to the load 410-1 and to the LDO 412 such that the filtered output voltage V_{OUT1} is applied to the load 410-1 and to the LDO 412. In the embodiment depicted in FIG. 4, each of the NMOS transistors M1, M3 is a high voltage transistor with a larger threshold voltage VT, allowing it to reject more ripple, which comes at the cost of headroom. To alleviate the headroom issue, the charge pump 404 or a suitable supply can be used to increase the gate voltage of the NMOS transistors M1, M3. The NMOS transistors M1, M3 help rejecting the ripple or noise at higher V_{IN}. Because the ripple is a function of the input voltage V_{IN}, for a lower input voltage V_{IN}, the ripple is also lower in magnitude. In the embodiment depicted in FIG. 4, the NMOS transistor M2 is a low voltage device, with a lower threshold voltage, and is used to reject the ripple at a lower V_{IN} voltage. The gate terminal G of the NMOS transistor M2 is biased using the resistor R1 and the capacitor C1, which may be connected to a fixed voltage, such as, the ground (zero volt). In some embodiments, the resistor R1 has a resistance value of several megohms and the capacitor C1 has a capacitance value of several picofarads. In some embodiments, the threshold voltage of each NMOS transistor M1, M2, or M3 is increased by connecting the body of the transistor to the ground. In the embodiment depicted in FIG. 4, the load 410-1 and the load 410-2 are isolated from each other. The load 410-2 may need more headroom but not necessarily require higher supply rejection. In some embodiments, the load 410-1 is an auto zeroed input buffer driving the input of an ADC, the voltage generated by the LDO 412 or a voltage reference circuit is used to provide a reference voltage to the ADC, and the load 410-2 is another LDO that is used to power the ADC.

In an example operation of the supply filter circuit 400, during powerup, the switches S1 and S2 are closed (conductive) because the charge pump input voltage is supplied by the load itself. Once the load 410-2 (e.g., an LDO) powers up, the LDO output can be used to drive the charge pump 404 to drive the gate of the NMOS transistor M1, which makes the supply filter circuit 400 self-contained, requiring no other supply voltages to drive the charge pump 404. For example, once the load 410-2 (e.g., an LDO) powers up, the load 410-2 can be used to open the switches S1 and S2, and the charge pump 404 reaches a sufficient voltage to drive the gate of the NMOS transistor M1. This timing can be controlled digitally or using an undervoltage detection (UVDET)/Power on Reset (POR) signal that monitors the load 410-2 (e.g., an LDO). For example, the POR/UVDET signal can be used to detect if the output voltage of the load 410-2 (e.g., as a regulator to be an input to the charge pump 404). On powerup, the output voltage of the load 410-2 may rise to reach a sufficient voltage to drive the charge pump 404. A POR/UVDET circuit can detect when the load 410-2 reaches a sufficient voltage, and its output signal can be used to open the switches S1 and S2, allowing the gate terminal of the transistor M1 to be driven by the charge pump 404.

The foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematic shown in the figures depict one exemplary arrangement of elements, additional intervening elements, devices, features, or components may be present in an embodiment of the depicted subject matter.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A supply filter circuit comprising:
a first transistor coupled to an input voltage;
a charge pump coupled to the first transistor; and
a second transistor coupled to the first transistor and configured to output a filtered output voltage based on the input voltage, wherein the first and second transistors have different threshold voltages.

2. The supply filter circuit of claim 1, further comprising a voltage source coupled to the second transistor.

3. The supply filter circuit of claim 2, wherein the voltage source is coupled to a gate terminal of the second transistor.

4. The supply filter circuit of claim 1, further comprising a capacitor coupled to the first transistor.

5. The supply filter circuit of claim 1, wherein the charge pump is coupled to a gate terminal of the first transistor.

6. The supply filter circuit of claim 1, further comprising a resistor and a capacitor coupled to the second transistor.

7. The supply filter circuit of claim 1, further comprising a low-dropout regulator (LDO) coupled to the charge pump.

8. The supply filter circuit of claim 7, wherein the LDO is configured to generate a drive voltage for the charge pump.

9. The supply filter circuit of claim 7, further comprising a switch coupled to the charge pump and to the first transistor.

10. The supply filter circuit of claim 1, wherein the first and second transistors comprise a plurality of N-channel Metal-Oxide-Semiconductor (NMOS) transistors.

11. The supply filter circuit of claim 1, wherein a body of the first transistor or the second transistor is coupled to a fixed voltage.

12. The supply filter circuit of claim 1, further comprising a third transistor coupled to the charge pump and configured to output a second filtered output voltage based on the input voltage.

13. The supply filter circuit of claim 12, wherein the first, second, and third transistors comprise a plurality of N-channel Metal-Oxide-Semiconductor (NMOS) transistors.

14. A supply filter circuit comprising:
a first N-channel Metal-Oxide-Semiconductor (NMOS) transistor coupled to an input voltage;
a charge pump coupled to a gate terminal of the first NMOS transistor; and
a second NMOS transistor coupled to the first NMOS transistor and configured to output a filtered output voltage based on the input voltage, wherein the first and second NMOS transistors have different threshold voltages.

15. The supply filter circuit of claim 14, further comprising a voltage source coupled to a gate terminal of the second NMOS transistor.

16. The supply filter circuit of claim 14, further comprising a resistor and a capacitor coupled to the second NMOS transistor.

17. The supply filter circuit of claim 14, further comprising a low-dropout regulator (LDO) coupled to the charge pump and configured to generate a drive voltage for the charge pump.

18. The supply filter circuit of claim 17, further comprising a switch coupled to the charge pump and to the first NMOS transistor.

19. The supply filter circuit of claim 14, wherein a body of the first NMOS transistor or the second NMOS transistor is coupled to a fixed voltage.

20. A supply filter circuit comprising:
a first N-channel Metal-Oxide-Semiconductor (NMOS) transistor coupled to an input voltage;
a charge pump coupled to a gate terminal of the first NMOS transistor;
a second NMOS transistor coupled to the first NMOS transistor and configured to output a filtered output voltage based on the input voltage, wherein the first and second NMOS transistors have different threshold voltages; and
a low-dropout regulator (LDO) coupled to the charge pump and configured to generate a drive voltage for the charge pump, wherein a body of the first NMOS transistor or the second NMOS transistor is coupled to a fixed voltage.
